(19) United States
(12) Patent Application Publication
(10) Pub. No.: US 2016/0061566 A1
(43) Pub. Date: Mar. 3, 2016

(54) AIMING APPARATUS USING DIGITAL MAGNIFICATION

(71) Applicants: Sintai Optical (Shenzhen) Co., Ltd., Shenzhen City (CN); Asia Optical International Ltd., Tortola (GB)

(72) Inventor: Tung-Ching Chen, Taichung (TW)

(21) Appl. No.: 14/833,164

(22) Filed: Aug. 24, 2015

(30) Foreign Application Priority Data
Aug. 28, 2014 (TW) 103129642

(51) Int. Cl. F41G 1/38; G02B 7/10; G02B 15/00; G02B 23/16; G02B 23/24

(52) U.S. Cl. CPC F41G 1/38; G02B 23/16; G02B 23/2446; G02B 15/00; G02B 7/10

(57) ABSTRACT

An aiming apparatus using digital magnification includes a main cylinder body, an object lens, an eyepiece, an erector device and a magnification ring. The main cylinder body includes a front end connecting to the object lens and a rear end connecting to the eyepiece. The erector device is disposed within the main cylinder body and includes an inner tube, an outer tube, a ring resistor board, a pogo pin and a parallel resistor. The inner tube jackets the outer tube. The pogo pin is disposed in the outer tube and contacts the ring resistor board. The ring resistor board connects to the parallel resistor in parallel. The magnification ring is rotatably disposed in the main cylinder body to rotate the outer tube with respect to the inner tube so as to change the contact position of the pogo ring on the ring resistor board.

### BACKGROUND OF THE INVENTION

1. Field of the Invention

The invention relates to an aiming apparatus using digital magnification.

2. Description of the Related Art

The present aiming apparatus in operation uses a measured distance of prey and the magnification of the aiming apparatus, through a ballistic compensation formula, to determine a ballistic compensation point. The ballistic compensation point is displayed by the screen of the aiming apparatus for a user to aim at prey before firing. For the present aiming apparatus, accuracy of the ballistic compensation point as well as hitting accuracy significantly depends on magnification accuracy.

An aiming apparatus using digital magnification has a magnification ring to adjust the digital magnification. The output voltage can be changed by rotation of the magnification ring. Different output voltages represent different digital magnifications. It is therefore understood that the accuracy of digital magnification significantly depends on the accuracy of the output voltage.

A known aiming apparatus using digital magnification with 4 times ratio (4-16×) is taken as an example for description. FIG. 1 depicts the relationship between the digital magnification and the rotation angle of the magnification ring, wherein the outer ring number represents the rotation angle of the magnification ring, and the inner ring number represents the digital magnification. The relationship between the digital magnification, rotation angle of the magnification ring, accumulated angle of the magnification ring, output voltage and output count number is shown in Table 1. It can be seen from FIG. 1 and Table 1 that the rotation angle of the magnification ring is equal to 6 degrees, the accumulated angle of the magnification ring is equal to 143 degrees, the output voltage is equal to 0.1385 V, and the output count number is equal to 172 as the digital magnification is between 15 and 16 times. Further, the rotation angle of the magnification ring is equal to 8 degrees, the accumulated angle of the magnification ring is equal to 137 degrees, the output voltage is equal to 0.1846 V, and the output count number is equal to 299 as the digital magnification is between 14 and 15 times. Further, the rotation angle of the magnification ring is equal to 23 degrees, the accumulated angle of the magnification ring is equal to 23 degrees, the output voltage is equal to 0.5308 V, and the output count number is equal to 659 as the digital magnification is between 4 and 5 times. Further, the rotation angle of the magnification ring is equal to 19 degrees, the accumulated angle of the magnification ring is equal to 42 degrees, the output voltage is equal to 0.4385 V, and the output count number is equal to 544 as the digital magnification is between 5 and 6 times. It is therefore understood that the relationship between the digital magnification and the rotation angle of the magnification ring is not linear. Rather, at high digital magnification (for example, 15-16 times, 14-15 times, etc.) the rotation angle of the magnification ring is small, and at low digital magnification (for example, 4-5 times, 5-6 times, etc.) the rotation angle of the magnification ring is large. At high digital magnification, any errors of the output voltage may reduce the digital magnification accuracy, increase position deviation of the ballistic compensation point and affect the hitting accuracy because the rotation angle of the magnification ring as well as the output voltage is relatively small.

TABLE 1

| Digital Magnification | 4-5 | 5-6 | 6-7 | 7-8 | 8-9 | 9-10 | 10-11 |
|---|---|---|---|---|---|---|---|
| Rotation angle of the | 23 | 19 | 16 | 14 | 12 | 11 | 10 |
| Magnification Ring (Degrees) | | | | | | | |
| Accumulated Angle of the | 23 | 42 | 58 | 72 | 84 | 95 | 105 |
| Magnification Ring (Degrees) | | | | | | | |
| Output Voltage (V) | 0.5308 | 0.4385 | 0.3692 | 0.3231 | 0.2769 | 0.2538 | 0.2308 |
| Output Count Number | 659 | 544 | 458 | 401 | 344 | 315 | 286 |

| Digital Magnification | 11-12 | 12-13 | 13-14 | 14-15 | 15-16 |
|---|---|---|---|---|---|
| Rotation angle of the | 9 | 8 | 7 | 8 | 6 |
| Magnification Ring (Degrees) | | | | | |
| Accumulated Angle of the | 114 | 122 | 129 | 137 | 143 |
| Magnification Ring (Degrees) | | | | | |
| Output Voltage (V) | 0.2077 | 0.1846 | 0.1615 | 0.1846 | 0.1385 |
| Output Count Number | 258 | 229 | 201 | 229 | 172 |

### BRIEF SUMMARY OF THE INVENTION

The invention provides an aiming apparatus using digital magnification to solve the above problems. The aiming apparatus using digital magnification is provided with an increased output voltage at high digital magnification so as to improve the accuracy of high digital magnification, the accuracy of the ballistic compensation point, and the hitting accuracy.

The aiming apparatus using digital magnification in accordance with an exemplary embodiment of the invention includes a main cylinder body, an object lens, an eyepiece, an erector device and a magnification ring. The main cylinder body includes a front end connecting to the object lens and a rear end connecting to the eyepiece. The erector device is disposed within the main cylinder body for adjusting a digital magnification and includes an inner tube, an outer tube, a ring resistor board, a pogo pin and a parallel resistor. The inner tube jackets the outer tube, an end of the outer tube connects to the ring resistor board. The pogo pin is disposed in the outer tube and contacts the ring resistor board, and the ring resistor board connects to the parallel resistor in parallel. The magnification ring is rotatably disposed in the main cylinder body to rotate the outer tube with respect to the inner tube so as to change the contact position of the pogo ring on the ring resistor board.

In another exemplary embodiment, a resistance of the ring resistor board is less than or equal to 143K ohms

In yet another exemplary embodiment, a resistance of the parallel resistor is equal to 150 k ohms

In another exemplary embodiment, a maximum accumulated angle of the magnification ring is a multiple of 143 degrees.

In yet another exemplary embodiment, a maximum accumulated angle of the magnification ring is equal to 143 degrees.

In another exemplary embodiment, a rotation angle of the magnification ring decreases nonlinearly as the digital magnification increases linearly.

In yet another exemplary embodiment, an accumulated angle of the magnification ring increases nonlinearly as the digital magnification increases linearly.

In another exemplary embodiment, the outer tube further includes an outer surface and the pogo pin is disposed on the outer surface.

In yet another exemplary embodiment, the erector device further includes a pin mount disposed on the outer surface, and the pogo pin connects to the pin mount.

In another exemplary embodiment, the aiming apparatus using digital magnification further includes a display unit disposed within the main cylinder body for displaying the digital magnification.

In yet another exemplary embodiment, the display unit is a transmissive liquid crystal display (LCD).

In another exemplary embodiment, the display unit is an organic light-emitting diode (OLED).

In yet another exemplary embodiment, the display unit is an active-matrix organic light-emitting diode (AMOLED).

In another exemplary embodiment, the aiming apparatus using digital magnification further includes a focusing ring rotatably disposed in the eyepiece to adjust a focus.

A detailed description is given in the following embodiments with reference to the accompanying drawings.

### BRIEF DESCRIPTION OF THE DRAWINGS

The invention can be more fully understood by reading the subsequent detailed description and example with references made to the accompanying drawings, wherein:

FIG. 1 is a relative relationship diagram between a digital magnification and a rotation angle of a magnification ring for a known aiming apparatus using digital magnification;

FIG. 2 is a schematic diagram of an aiming apparatus using digital magnification in accordance with an embodiment of the invention;

FIG. 3A is a schematic diagram of an erector device of the aiming apparatus using digital magnification in accordance with the embodiment of the invention;

FIG. 3B is a schematic diagram of a partial exploded view of the erector device of the aiming apparatus using digital magnification in accordance with the embodiment of the invention; and

FIG. 4 is a schematic diagram of a voltage division system of a ring resistor board of the erector device of the aiming apparatus using digital magnification in accordance with the embodiment of the invention.

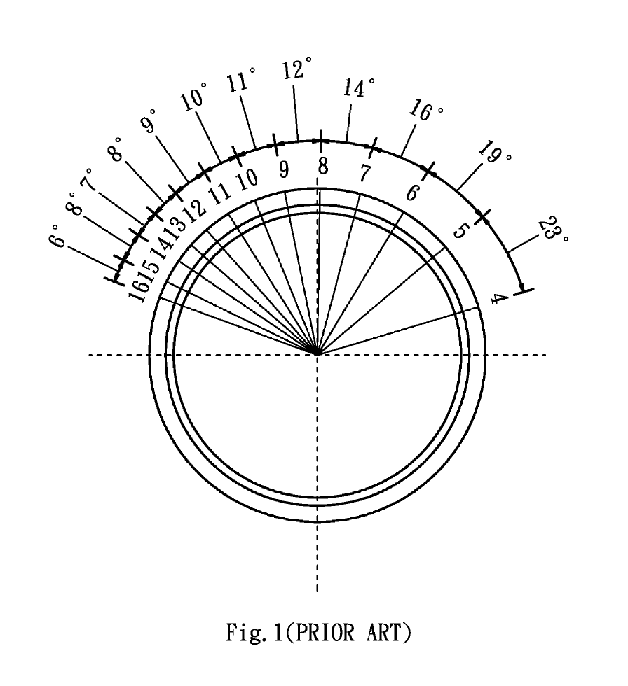

### DETAILED DESCRIPTION OF THE INVENTION

The following description is made for the purpose of illustrating the general principles of the invention and should not be taken in a limiting sense. The scope of the invention is best determined by reference to the appended claims.

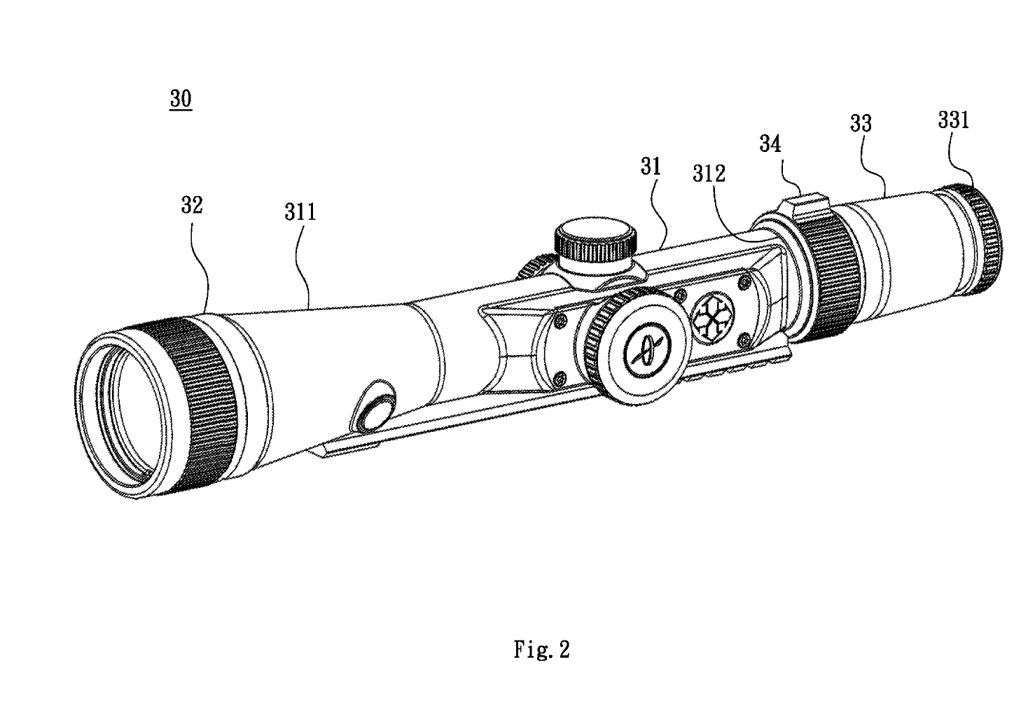

Referring to FIG. 2, FIG. 2 is a schematic diagram of an aiming apparatus using digital magnification in accordance with an embodiment of the invention. The aiming apparatus using digital magnification 30 includes a main cylinder body 31, an object lens 32, an eyepiece 33 and a magnification ring 34. The main cylinder body 31 includes a front end 311 which is connected to the object lens 32 and a rear end 312 which is connected to the eyepiece 33. A focusing ring 331 is disposed on the surface of the eyepiece 33 and can be rotated to adjust focus. The magnification ring 34 is disposed on the surface of the rear end 312. The inner of the main cylinder body 31 includes an erector device (not shown) and a display unit (not shown). Users can rotate magnification ring 34 to adjust a digital magnification. The rotation angle of the magnification ring 34 is up to 143 degrees. The display unit (not shown) can display the digital magnification for users to view.

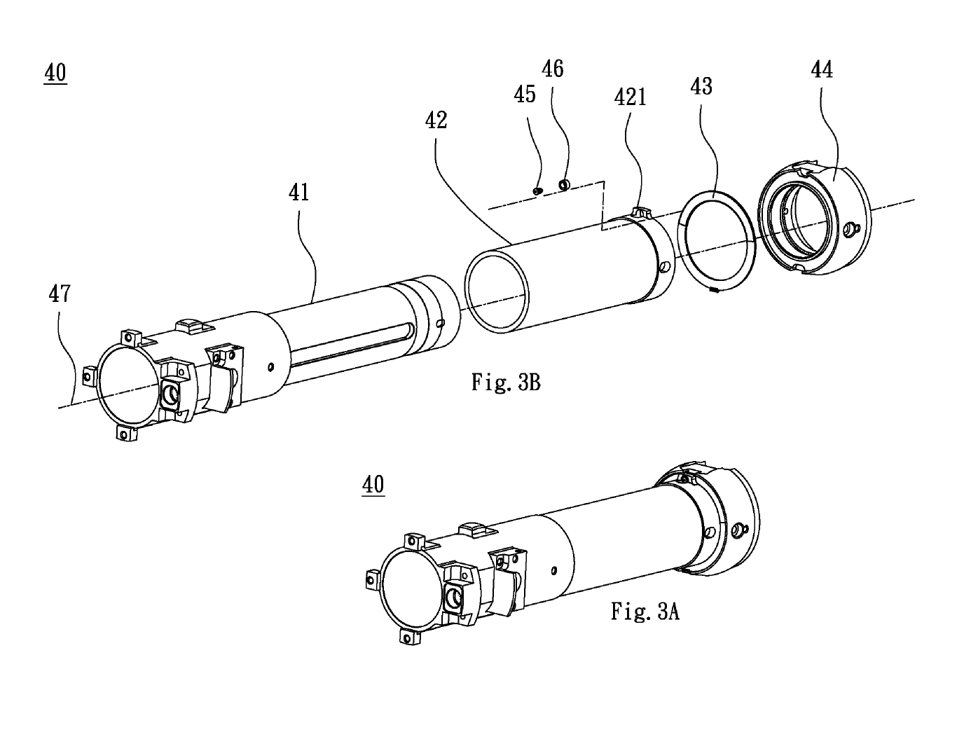

The erector device is illustrated by FIG. 3A and FIG. 3B, wherein FIG. 3A is a schematic diagram of an erector device of the aiming apparatus using digital magnification in accordance with the embodiment of the invention and FIG. 3B is a schematic diagram of a partial exploded view of the erector device of the aiming apparatus using digital magnification in accordance with the embodiment of the invention. The erector device 40 includes an inner tube 41, an outer tube 42, a pin mount 421, a ring resistor board 43, a ring resistor board socket 44, a pogo pin 45, an insulator 46 and a parallel resistor (not shown). The ring resistor board 43 connects to the parallel resistor (not shown) in parallel, then connects to the ring resistor board socket 44, and then connects to an end of the outer tube 42. The pin mount 421 is disposed on the outer surface of the outer tube 42. The pogo pin 45 is jacketed by the insulator 46, connected to the pin mount 421, and configured to contact the ring resistor board 43. The outer tube 42 jackets the inner tube 41. The outer tube 42 can be rotated around the axis 47 with respect to the inner tube 41, for driving the pogo pin 45 to rotate so that the pogo pin 45 can contact the ring resistor board 43 at different positions. By this arrangement, the resistance of the ring resistor board 43 can be changed because the different surface positions of the ring resistor board 43 have different resistances. When users rotate the magnification ring 34 (FIG. 2) to drive the outer tube 42 to rotate with respect to the inner tube 41, the contact position of the pogo pin 45 and the ring resistor board 43 is changed, the resistance of the ring resistor board is changed, and the output voltage of the ring resistor board is changed so that the digital magnification can be adjusted.

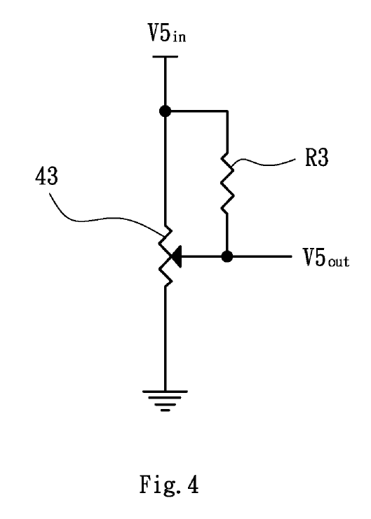

Referring to FIG. 4, FIG. 4 is a schematic diagram of a voltage division system of a ring resistor board of the erector device of the aiming apparatus using digital magnification in accordance with the embodiment of the invention. In the embodiment of the invention, the voltage division system of the ring resistor board is configured to include a parallel resistor R3. The ring resistor board 43, having an end connected to a power source V5ᵢₙ and the other end grounded, connects to a parallel resistor R3 in parallel. The input voltage of the ring resistor board 43 is 3.3V. At high digital magnification, the output voltage V5ₒᵤₜ of the ring resistor board 43 increases because of the parallel resistor connected to the ring resistor board 43. Thus, the output count number increases after analog to digital conversion so as to increase the accuracy of the high digital magnification. In the embodiment of the invention, the resistance of the ring resistor board 43 can be changed from 0 k ohms to 143 k ohms because the contact position of the pogo pin (FIG. 3B) and the ring resistor board 43 can be changed. The resistance of the parallel resistor R3 is equal to 150 k ohms In order to cooperate with the rotation angle range of the magnification ring, the largest resistance of the above ring resistor board is selected as 143 k ohms Thus, the variation of the resistance of the ring resistor board is 1 k ohms when the magnification ring is rotated through 1 degree. Further, the resistance of the parallel resistor R3 is selected as 150 k ohms to reduce the difference between the output count number at high digital magnification and the output count number at low digital magnification. The digital magnification can be determined more correctly through the above selected resistances.

Table 2 shows the relationship between digital magnification, rotation angle of the magnification ring, accumulated angle of the magnification ring, output voltage and output count number when the voltage division system of the ring resistor board is configured to include a parallel resistor. It can be seen from Table 2 that the rotation angle of the magnification ring is equal to 6 degrees, the accumulated angle of the magnification ring is equal to 143 degrees, the output voltage is equal to 0.2551 V, and the output count number is equal to 317 as the digital magnification is between 15 and 16 times. The rotation angle of the magnification ring is equal to 8 degrees, the accumulated angle of the magnification ring is equal to 137 degrees, the output voltage is equal to 0.2991 V, and the output count number is equal to 371 as the digital magnification is between 14 and 15 times. The rotation angle of the magnification ring is equal to 23 degrees, the accumulated angle of the magnification ring is equal to 23 degrees, the output voltage is equal to 0.4703 V, and the output count number is equal to 584 as the digital magnification is between 4 and 5 times. The rotation angle of the magnification ring is equal to 19 degrees, the accumulated angle of the magnification ring is equal to 42 degrees, the output voltage is equal to 0.3389 V, and the output count number is equal to 421 as the digital magnification is between 5 to 6 times. In one word, the digital magnification increases linearly from 4-5 times to 15-16 times, but the rotation angle of the magnification ring decreases nonlinearly and the accumulated angle of the magnification ring increases nonlinearly. It can be seen from Table 1 and Table 2 that the output voltage increases from 0.1385 V to 0.2551 V and the output account number increases from 172 to 317 as the digital magnification is between 15 and 16 times and the voltage division system of a ring resistor board is configured to include a parallel resistor. The output voltage increases from 0.1846 V to 0.2991 V and the output account number increases from 229 to 371 as the digital magnification is between 14 and 15 times and the voltage division system of a ring resistor board is configured to include a parallel resistor. It is obvious that the output voltage and the output count number of the high digital magnification increases significantly so as to increases the accuracy of the digital magnification of the high digital magnification, reduce ballistic compensation point position deviation and improve the firing accuracy when the voltage division system of a ring resistor board is configured to include a parallel resistor.

Table 2 shows that the maximum accumulated angle of the magnification ring is equal to 143 degrees. However, it has the same effect and falls into the scope of the invention if the maximum accumulated angle of the magnification ring is designed to a multiple of 143 degrees.

TABLE 2

| Digital Magnification | 4-5 | 5-6 | 6-7 | 7-8 | 8-9 | 9-10 | 10-11 |
|---|---|---|---|---|---|---|---|
| Rotation Angle of the | 23 | 19 | 16 | 14 | 12 | 11 | 10 |
| Magnification Ring (Degrees) | | | | | | | |
| Accumulated Angle of the | 23 | 42 | 58 | 72 | 84 | 95 | 105 |
| Magnification Ring (Degrees) | | | | | | | |
| Output Voltage (V) | 0.4703 | 0.3389 | 0.2791 | 0.2534 | 0.2329 | 0.2333 | 0.2351 |
| Output Count Number | 584 | 421 | 346 | 315 | 289 | 290 | 292 |

| Digital Magnification | 11-12 | 12-13 | 13-14 | 14-15 | 15-16 |
|---|---|---|---|---|---|
| Rotation Angle of the | 9 | 8 | 7 | 8 | 6 |
| Magnification Ring (Degrees) | | | | | |
| Accumulated Angle of the | 114 | 122 | 129 | 137 | 143 |
| Magnification Ring (Degrees) | | | | | |
| Output Voltage (V) | 0.2364 | 0.2355 | 0.2308 | 0.2991 | 0.2551 |
| Output Count Number | 293 | 292 | 286 | 371 | 317 |

In the above embodiment of the invention, the display unit may be a transmissive liquid crystal display (LCD) or an organic light-emitting diode (OLED) or an active-matrix organic light-emitting diode (AMOLED).

What is claimed is:

1. An aiming apparatus using digital magnification, comprising:
a main cylinder body comprising a front end and a rear end;
an object lens connecting to the front end;
an eyepiece connecting to the rear end;
an erector device, disposed within the main cylinder body for adjusting a digital magnification, which comprises an inner tube, an outer tube, a ring resistor board, a pogo pin and a parallel resistor, wherein the inner tube jackets the outer tube, an end of the outer tube connects to the ring resistor board, the pogo pin is disposed in the outer tube and contacts the ring resistor board, and the ring resistor board connects to the parallel resistor in parallel; and
the magnification ring is rotatably disposed in the main cylinder body to rotate the outer tube with respect to the inner tube so as to change the contact position of the pogo ring on the ring resistor board.

2. The aiming apparatus using digital magnification as claimed in claim 1,
wherein a resistance of the ring resistor board is less than or equal to 143K ohms.

3. The aiming apparatus using digital magnification as claimed in claim 1,
wherein a resistance of the parallel resistor is equal to 150 k ohms.

4. The aiming apparatus using digital magnification as claimed in claim 1,
wherein a maximum accumulated angle of the magnification ring is a multiple of 143 degrees.

5. The aiming apparatus using digital magnification as claimed in claim 4,
wherein a maximum accumulated angle of the magnification ring is equal to 143 degrees.

6. The aiming apparatus using digital magnification as claimed in claim 1,
wherein a rotation angle of the magnification ring decreases nonlinearly as the digital magnification increases linearly.

7. The aiming apparatus using digital magnification as claimed in claim 1,
wherein an accumulated angle of the magnification ring increases nonlinearly as the digital magnification increases linearly.

8. The aiming apparatus using digital magnification as claimed in claim 1,
wherein the outer tube comprises an outer surface and the pogo pin is disposed on the outer surface.

9. The aiming apparatus using digital magnification as claimed in claim 8,
wherein the erector device further comprises a pin mount disposed on the outer surface, and the pogo pin connects to the pin mount.

10. The aiming apparatus using digital magnification as claimed in claim 1,
further comprising a display unit disposed within the main cylinder body for displaying the digital magnification.

11. The aiming apparatus using digital magnification as claimed in claim 10,
wherein the display unit is a transmissive liquid crystal display (LCD).

12. The aiming apparatus using digital magnification as claimed in claim 10,
wherein the display unit is an organic light-emitting diode (OLED).

13. The aiming apparatus using digital magnification as claimed in claim 10,
wherein the display unit is an active-matrix organic light-emitting diode (AMOLED).

14. The aiming apparatus using digital magnification as claimed in claim 1,
further comprising a focusing ring rotatably disposed in the eyepiece to adjust a focus.
